(19) United States
(12) Patent Application Publication
(10) Pub. No.: US 2005/0263377 A1
(43) Pub. Date: Dec. 1, 2005

(54) Electronic device and keyboard thereof

(75) Inventor: Lai Shi Huang, Taipei (TW)

Correspondence Address: QUINTERO LAW OFFICE, 1617 BROADWAY, 3RD FLOOR, SANTA MONICA, CA, 90404, US

(73) Assignee: WISTRON CORP., TAIPEI HSIEN (TW)

(21) Appl. No.: 10/959,357

(22) Filed: Oct. 6, 2004

(30) Foreign Application Priority Data
May 31, 2004 (TW) TW93115490

(51) Int. Cl. H01H 9/00

(52) U.S. Cl. 200/5 A

(57) ABSTRACT

An electronic device and a keyboard thereof. The keyboard, provided with a plurality of key positions, comprises a first circuit board having a plurality of first conductors corresponding to the key positions, a second circuit board corresponding to the first circuit board and having a plurality of second conductors opposite to the first conductors, an isolation layer disposed between the first and second circuit boards comprising a plurality of through holes through which the first conductors contact the corresponding second conductors, and a vibration module connected to the second circuit board. When the first circuit board is pressed causing the first conductor to contact the second conductor, the vibration module vibrates the first and second circuit boards.

### BACKGROUND

1. Field of the Invention

The invention relates to an electronic device, and in particular to an electronic device provided with a keyboard capable of vibrating or emitting sound.

2. Description of the Related Art

A key structure of a conventional keyboard is depicted in FIG. 1. A key cap 40 is supported by a truss 50, and an elastic member 60 is disposed over a first circuit board 10. When a user presses the key cap 40, a first conductor 12 on the first circuit board 10 is pressed to contact a second conductor 14 on a second circuit board 20 opposite to the first circuit board 10 so as to create touch signal that is sent to an electronic device such as a computer for displaying a corresponding letter or number. When the user releases the key cap 40, the elastic member 60 pushes the key cap 40 back. Thereby, physical feedback is provided by means of the key cap 40 moving up and down.

In such a structure, each key must be provided with a key cap, a truss and an elastic member. Thus, the operational procedure is relatively complicated. In addition, because a keyboard is provided with so many keys, it is possible for some of the keys to be poorly assembled. Thus, elimination of the key cap and other members can reduce cost and increase yield.

### SUMMARY

An embodiment of a keyboard of the invention comprises a first circuit board comprising a plurality of first conductors corresponding to key positions of the keyboard, a second circuit board corresponding to the first circuit board and comprising a plurality of second conductors opposite to the first conductors, an isolation layer disposed between the first and second circuit boards and comprising a plurality of through holes within which the first conductors contact the corresponding second conductors, and a vibration module connected to the second circuit board, wherein when the first circuit board is pressed to make the first conductor contact the second conductor, the vibration module vibrates the first and second circuit boards.

The vibration module comprises at least one vibrator connected to the second circuit board for vibrating the second circuit board.

The vibration module further comprises a wave generator connected to the second circuit board, a digital/analog converter connected to the wave generator and a power amplifier connected to the digital/analog converter and the vibrator. When the first conductor contacts the second conductor, a touch signal is sent to the wave generator from the second circuit board and processed by the digital/analog converter and the power amplifier to produce an appropriate current for vibrating the second circuit board.

The vibrator comprises a vibrating element connected to the second circuit board, a coil surrounding the vibrating element and a magnetic circuit disposed in the vibrating element and corresponding to the coil, wherein a current flows in the coil to actuate the vibrating element.

Thereby, when a user presses a key which can be a pattern printed on the first circuit board, the vibration of the first circuit board provides physical feedback.

A detailed description is given in the following embodiments with reference to the accompanying drawings.

### BRIEF DESCRIPTION OF THE DRAWINGS

Embodiments of the invention can be more fully understood by reading the subsequent detailed description and examples with references made to the accompanying drawings, wherein:

FIG. 1 is a schematic view of a conventional keyboard;

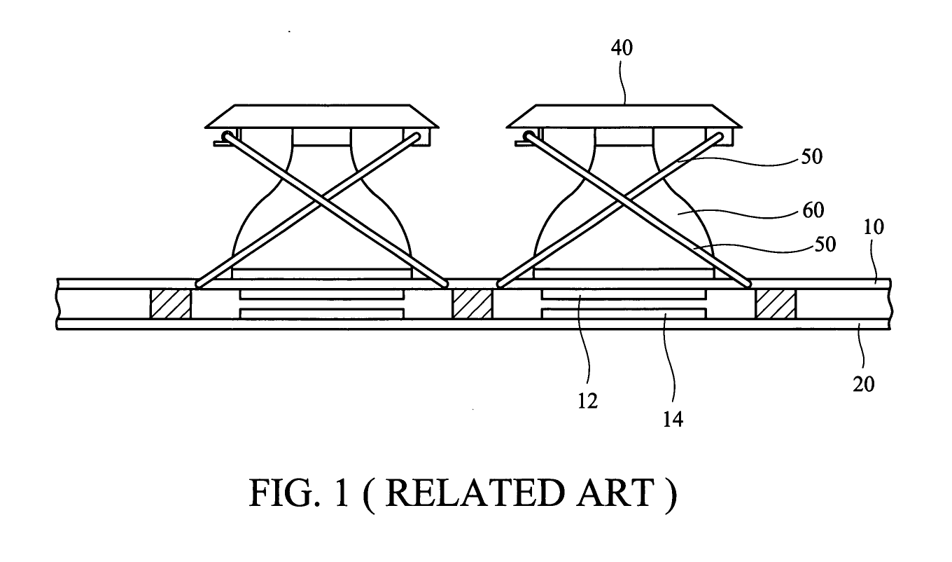

FIG. 2 is a schematic view of an embodiment of a keyboard of the invention;

FIG. 3 is a schematic view of an embodiment a keyboard of the invention showing the keyboard being pressed;

FIG. 4 is a block diagram of a vibration module of an embodiment of the invention; and

FIG. 5 is a cross section of a vibrator of an embodiment of the invention.

### DETAILED DESCRIPTION

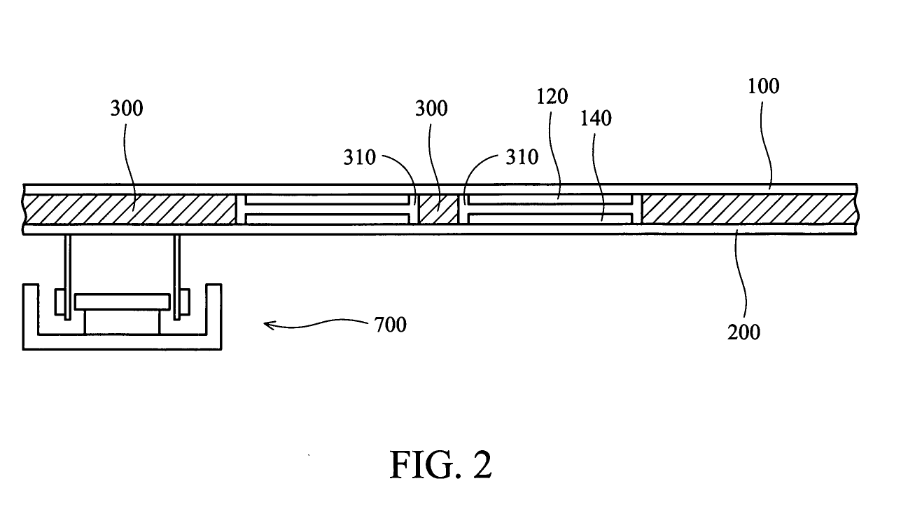

Referring to FIG. 2, an embodiment of a keyboard of the invention comprises a first circuit board 100, a second circuit board 200 corresponding to the first circuit board 100 and a isolation layer 300 disposed between the first circuit board 100 and the second circuit board 200 to prevent short-circuits between the first and second circuit boards 100, 200. This embodiment further comprises a vibrator 700 connected to the second circuit board 200.

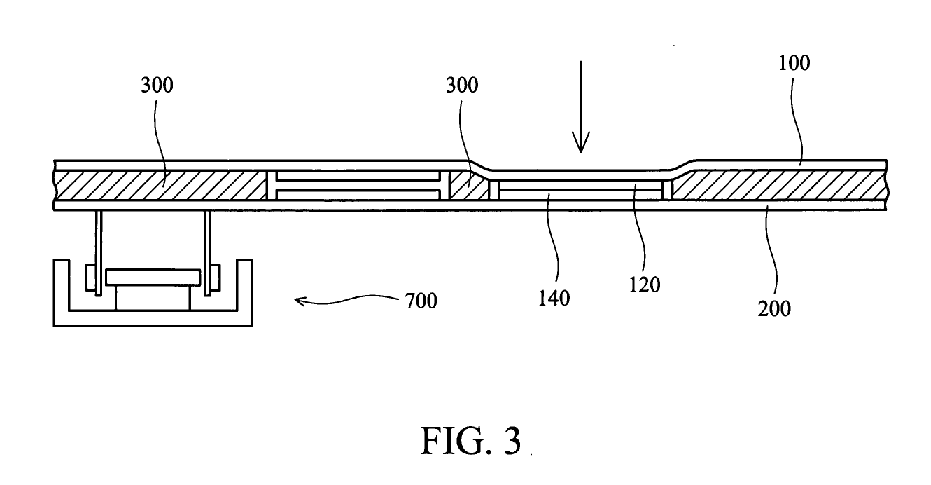

Because the keyboard of the invention does not use key caps as in a conventional keyboard, a key pattern indicating key positions can be printed on the first circuit board 100 for easy manipulation. A plurality of first conductors 120 corresponding to each key position of the keyboard is disposed on the first circuit board 100. A plurality of second conductors 140 corresponding to the first conductors 120 is disposed on the second circuit board 200. The second conductors 140 oppose the first conductors 120. A plurality of through holes 310 corresponding to the first and second conductors 120, 140 is defined on the isolation layer 300. When a user presses a key, the first conductor 120 contacts the second conductor 140 via the through hole 310, as shown in FIG. 3, to produce a touch signal. The touch signal enables the vibrator 700 to vibrate the second circuit board 200, and the vibration propagates to the first circuit board 100 providing physical feedback.

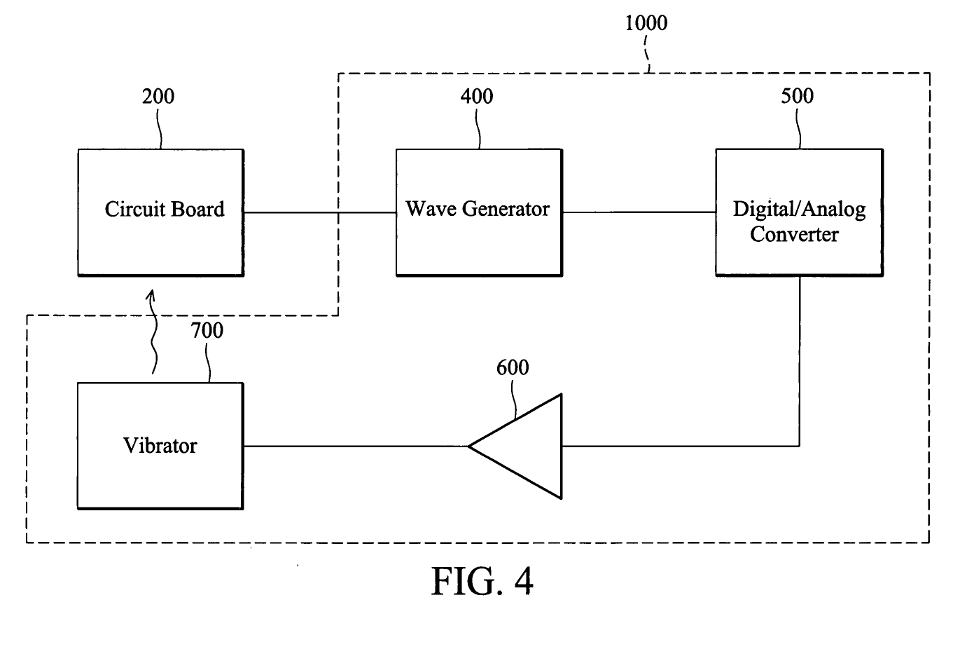

The vibration of the vibrator 700 is described in detail with reference to FIG. 4. A vibration module 1000 comprises a wave generator 400, a digital/analog converter 500, a power amplifier 600 and a vibrator 700. The mentioned touch signal is transmitted from the second circuit board 200 to the wave generator 400 to determine a wave form of the vibration. The digital touch signal is converted to an analog signal by the digital/analog converter 500 and amplified by the power amplifier 600. The amplified touch signal is input to the vibrator 700 to vibrate the second circuit board 200.

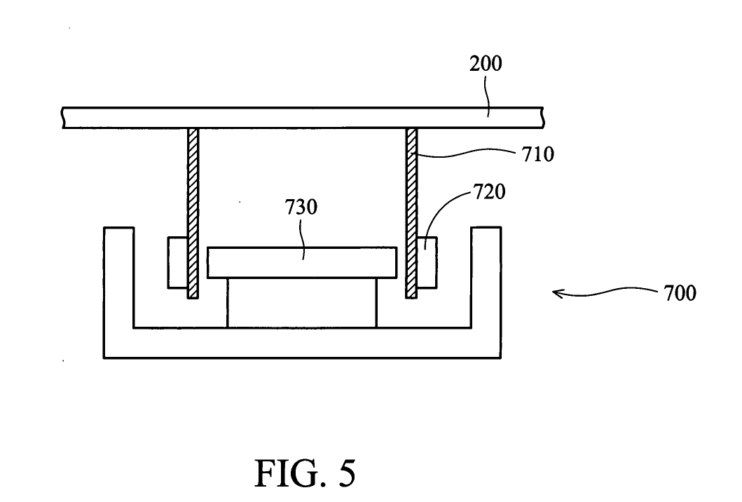

The vibrator 700 is modified from a moving coil speaker. The vibrator 700 of this embodiment is depicted in FIG. 5. As shown in FIG. 5, a vibrating element 710 is connected to the second circuit board 200. A coil 720 surrounds the vibrating element 710, and a magnetic circuit 730 is disposed inside the vibrating element 710. When current flows in the coil 720, a magnetic interaction (characterized by the Fleming left hand rule) caused by the coil 720 and the magnetic circuit 730 enables the vibrating element 710 to vibrate the second circuit board 200, thereby providing physical feedback. The vibration can also emit sound; thereby the vibrator 700 can serve as a speaker.

The wave generator 400 can create various wave forms according to different vibration modes provided for the vibrator 700. In addition, the keyboard can be provided with a plurality of vibrators 700 corresponding to respective key positions, thereby providing various levels of physical feedback.

Although the previously described embodiment is directed to a keyboard, the key structure of the invention can also be applied to functional keys of a notebook computer or a personal digital assistant (PDA), which is provided with only one first conductor and one second conductor.

The keyboard of the invention can also be applied to a notebook computer, a PDA or a mobile communication device.

In the invention, since vibration is provided for the circuit boards of the keyboard by a vibrator connected to the circuit boards, even without key caps, a key pattern indicting key positions can be printed on the circuit board. Thereby, assembly time and cost can be reduced and product yield can be increased.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A key structure, comprising:
a first circuit board comprising a first conductor;
a second circuit board corresponding to the first circuit board comprising a second conductor opposite to the first conductor;
an isolation layer disposed between the first and second circuit boards with a through hole through which the first conductor contacts the second conductor; and
a vibration module connected to the second circuit board;
wherein when the first circuit board is pressed causing the first conductor to contact the second conductor, the vibration module vibrates the first and second circuit boards.

2. The key structure as claimed in claim 1, wherein the vibration module comprises a vibrator connected to the second circuit board for vibrating the second circuit boards.

3. The key structure as claimed in claim 1, wherein the vibration module further comprises:
a wave generator connected to the second circuit board;
a digital/analog converter connected to the wave generator; and
a power amplifier connected to the digital/analog converter and the vibrator;
when the first conductor contacts the second conductor, a touch signal is sent to the wave generator from the second circuit board and processed by the digital/analog converter and the power amplifier to produce an appropriate current for the vibrator to vibrate the second circuit board.

4. The key structure as claimed in claim 2, wherein the vibrator comprises:
a vibrating element connected to the second circuit board;
a coil surrounding the vibrating element; and
a magnetic circuit disposed in the vibrating element and corresponding to the coil;
wherein a current flows in the coil to actuate the vibrating element.

5. A keyboard with a plurality of key positions, the keyboard comprising:
a first circuit board having a plurality of first conductors corresponding to the key positions;
a second circuit board corresponding to the first circuit board, comprising a plurality of second conductors opposite to the first conductors;
an isolation layer disposed between the first and second circuit boards with a plurality of through holes corresponding to the first and second conductors, through which the first conductors contact the corresponding second conductors; and
a vibration module connected to the second circuit board;
wherein when the first circuit board is pressed causing the first conductor to contact the second conductor, the vibration module vibrates the first and second circuit boards.

6. The keyboard as claimed in claim 5, wherein the vibration module comprises at least one vibrator connected to the second circuit board for vibrating the second circuit board.

7. The keyboard as claimed in claim 5, wherein the vibration module further comprises:
a wave generator connected to the second circuit board;
a digital/analog converter connected to the wave generator; and
a power amplifier connected to the digital/analog converter and the vibrator;
wherein when the first conductor contacts the second conductor, a touch signal is sent to the wave generator from the second circuit board and processed by the digital/analog converter and the power amplifier to vibrate the second circuit board.

8. The keyboard as claimed in claim 6, wherein the vibrator comprises:
a vibrating element connected to the second circuit board;
a coil surrounding the vibrating element; and
a magnetic circuit disposed in the vibrating element and corresponding to the coil;
wherein a current flows in the coil to actuate the vibrating element.

9. The keyboard as claimed in claim 5, wherein the vibrating module comprises a plurality of vibrators corresponding to the key positions and connected to the second circuit board to vibrate the second circuit board.

10. An electronic device comprising:
a keyboard with a plurality of key positions, which comprise:
a first circuit board comprising a plurality of first conductors corresponding to the key positions;
a second circuit board corresponding to the first circuit board and comprising a plurality of second conductors opposite to the first conductors; and
an isolation layer disposed between the first and second circuit boards with a plurality of through holes through which the first conductors contact the corresponding second conductors; and
a vibration module connected to the second circuit board;
wherein when the first circuit board is pressed causing the first conductor to contact the second conductor, the vibration module vibrates the first and second circuit boards.

11. The electronic device as claimed in claim 10, wherein the vibration module comprises at least one vibrator connected to the second circuit board for vibrating the second circuit board.

12. The electronic device as claimed in claim 10, wherein the vibration module further comprises:
a wave generator connected to the second circuit board;
a digital/analog converter connected to the wave generator; and
a power amplifier connected to the digital/analog converter and the vibrator;
wherein when the first conductor contacts the second conductor, a touch signal is sent to the wave generator from the second circuit board and processed by the digital/analog converter and the power amplifier to produce an appropriate current for the vibrator to vibrate the second circuit board.

13. The electronic device as claimed in claim 11, wherein the vibrator comprises:
a vibrating element connected to the second circuit board;
a coil surrounding the vibrating element; and
a magnetic circuit disposed in the vibrating element and corresponding to the coil;
wherein a current flows through the coil to actuate the vibrating element so as to vibrate the second circuit board, thereby providing push feeling or sounding.

14. The electronic device as claimed in claim 10, wherein the vibration module comprises a plurality of vibrators corresponding to the key positions and connected to the second circuit board to vibrate the second circuit board.

15. The electronic device as claimed in claim 10, wherein the electronic device is a notebook computer.

16. The electronic device as claimed in claim 10, wherein the electronic device is a personal digital assistant (PDA).

17. The electronic device as claimed in claim 10, wherein the electronic device is a mobile communication device.
